(19) United States
(12) Patent Application Publication
(10) Pub. No.: US 2025/0198446 A1
(43) Pub. Date: Jun. 19, 2025

(54) Tension Control Fastener & Verification System

(71) Applicant: Allfasteners USA, LLC, Medina, OH (US)

(72) Inventors: Bruce A. Carmichael, Hinckley, OH (US); Anthony Carmichael, Strongsville, OH (US)

(73) Assignee: Allfasteners USA, LLC, Medina, OH (US)

(21) Appl. No.: 18/982,566

(22) Filed: Dec. 16, 2024

Related U.S. Application Data
(60) Provisional application No. 63/609,910, filed on Dec. 14, 2023.

(51) Int. Cl. F16B 31/02; F16B 37/00

(52) U.S. Cl. CPC F16B 31/021; F16B 37/00

(57) ABSTRACT

A fastening system for receiving an associated screw for joining parts together to form a structure. The fastening system includes a structural nut and a breakaway nut having a circumference that includes a shape that is configured to be engaged by a hand tool for rotating the breakaway nut. Upon rotation of the breakaway nut with respect to the associated screw, the structural nut is tightened against the structure to a desired tension whereupon the breakaway nut is dimensioned and configured to shear apart from the structural nut.

### CROSS REFERENCE TO RELATED APPLICATION

This application claims priority to co-pending U.S. Provisional Application Ser. No. 63/609,910 filed Dec. 14, 2023, entitled “Tension Control Fastener & Verification System,” the entire contents of which is incorporated herein by reference.

### FIELD

The present disclosure is directed to a fastening system for providing consistent tension of a structural nut and an associated verification system for quickly ensuring a plurality of nuts are installed at an installation site at a verified tension.

### BACKGROUND

In virtually any installation/assembly situation, it is important for the fasteners that are used to secure one assembly piece to another assembly piece to be sufficiently tightened to a desired tension. In many situations, it is relatively easy to confirm that an installer has sufficiently tightened the fasteners by manual confirmation. However, this can be very time consuming for installation sites that require a large number of fasteners. There may also be certain installation sites that give rise to dangerous situations for manual inspections of the fasteners. For example, cell towers would require another person in addition to the installer to climb the tower in order to manually inspect the fasteners.

What is needed therefore is a fastening system that provides desired tension control for particular applications and an inspection system that provides for a safe and efficient system to ensure the fasteners are tightened to the desired tension.

### SUMMARY

The above and other needs are met by a fastening system for receiving an associated screw for joining parts together to form a structure. The fastening system includes a structural nut and a breakaway nut. The breakaway nut includes a circumference having a shape that is configured to be engaged by a hand tool for rotating the breakaway nut. Upon rotation of the breakaway nut with respect to the associated screw, the structural nut is tightened against the structure to a desired tension whereupon the breakaway nut is dimensioned and configured to shear apart from the structural nut.

According to certain embodiments, the fastening system further includes a neck portion for joining the breakaway nut to the structural nut.

According to certain embodiments, the circumference of the breakaway nut and neck portion are dimensioned and configured to prevent the hand tool from applying a rotational force directly to the structural nut prior to the breakaway nut being sheared apart from the structural nut.

According to certain embodiments, the structural nut has a circumference that includes a shape that is configured to be engaged by a hand tool for rotating the structural nut after the breakaway nut is sheared apart from the structural nut.

According to another embodiment of the disclosure, a method for verifying proper installation of a structure at an installation site includes providing a plurality of fastening systems each for receiving an associated screw for joining parts together to form the structure at the installation site. Each of the plurality of fastening systems include a structural nut and a breakaway nut. The breakaway nut has a circumference that includes a shape that is configured to be engaged by a hand tool for rotating the breakaway nut, the breakaway nut being operable to shear away from the structural nut upon the structural nut being tightened against the structure to a desired tension. The method further includes installing the plurality of fastening systems to construct the structure by applying each of the fastening systems to one of a plurality of bolts inserted into the structure and tightening each of the structural nuts to the desired tension with respect to the structure by applying torque to the breakaway nuts until the breakaway nuts shear away from each of their respective structural nuts; and verifying that each of the structural nuts have been sufficiently tightened with respect to the structure by visually confirming that each of the breakaway nuts have been sheared away from each of their respective structural nuts.

According to certain embodiments, the providing step includes providing a first set of fastening systems and a second set of fastening systems, the first set of fastening systems having a first desired tension in which the breakaway nut is operable to shear away from the structural nut and the second set of fastening systems having a second desired tension in which the breakaway nut is operable to shear away from the structural nut, and the second desired tension being different than the first desired tension.

According to certain embodiments, the installing step includes selecting one of the first set of fastening systems and the second set of fastening systems for installation based at least in part on the desired tension being one of the first desired tension and the second desired tension.

According to certain embodiments, each of the plurality of fastening systems further include a neck portion for joining the breakaway nut to the structural nut.

According to certain embodiments, the circumference of the breakaway nut for each of the plurality of fastening systems is dimensioned and configured to prevent the hand tool from applying a rotational force directly to the structural nut prior to the breakaway nut being sheared apart from the structural nut.

According to certain embodiments, the structural nut of each of the plurality of fastening systems has a circumference that includes a shape that is configured to be engaged by a hand tool for rotating the structural nut after the breakaway nut is sheared apart from the structural nut.

### BRIEF DESCRIPTION OF THE DRAWINGS

Other embodiments of the invention will become apparent by reference to the detailed description in conjunction with the figures, wherein elements are not to scale so as to more clearly show the details, and wherein like reference numbers indicate like elements throughout the several views, and wherein:

FIG. 1 depicts a front perspective view of a fastening system according to one embodiment of the disclosure.

FIG. 2 depicts a side elevation view of the fastening system of FIG. 1.

FIG. 3 depicts a bottom elevation view of the fastening system of FIGS. 1-2.

FIG. 3A depicts a cross-sectional view of the fastening system taken along line AA of FIG. 3.

FIG. 4 depicts a flow chart of a method for verifying proper installation of a plurality of fastening systems at an installation site according to one embodiment of the disclosure.

### DETAILED DESCRIPTION

The following description of preferred embodiments for this disclosure is presented for purposes of illustration and description. It is not intended to be exhaustive or to limit the disclosure to the precise form disclosed. Obvious modifications or variations are possible in light of the following teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure.

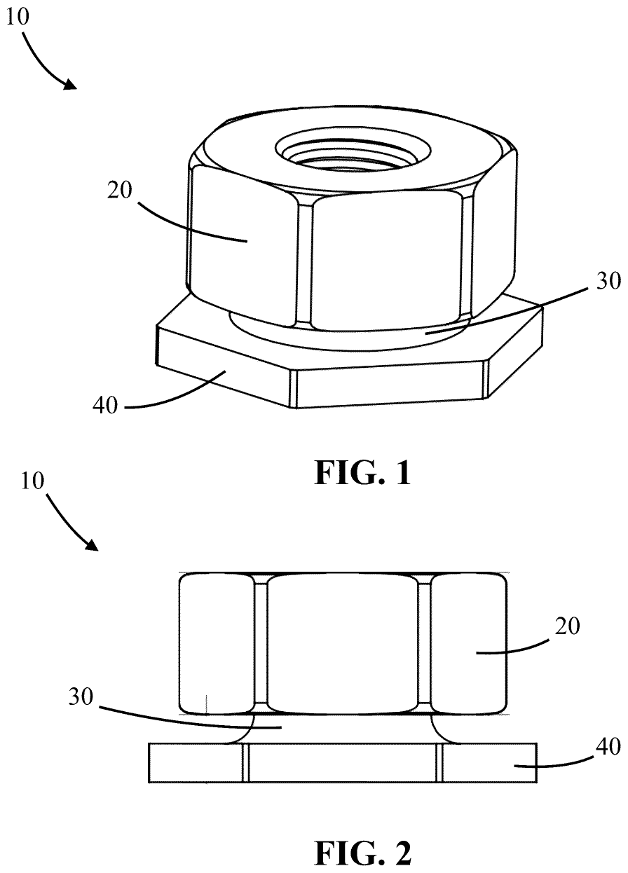

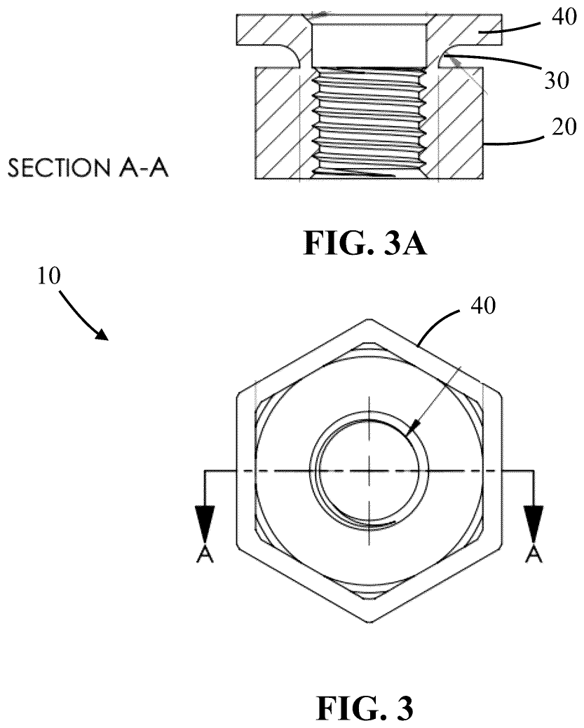

With reference to FIGS. 1-3, the present disclosure provides a fastening system 10 for receiving an associated bolt or screw (not shown) for joining parts together to form a structure. The fastening system 10 generally includes a structural nut 20, a breakaway nut 40, and a neck portion 30 that connects the structural nut 20 to the breakaway nut 40. At least the breakaway nut 40 includes a shape (e.g., hexagonal) such that it is configured to be engaged by a hand tool (e.g., socket wrench) for rotating the breakaway nut 40. Upon rotation of the breakaway nut 40, the structural nut 20 is similarly rotated around the associated bolt or screw to tighten the structural nut 20 with respect to the structure that is intended to be fastened by the fastening system 10. More specifically, the neck portion 30 and/or breakaway nut 40 of fastening system 10 are dimensioned and configured such that the breakaway nut 40 will break apart/shear from the structural nut 20 at a desired tension of the structural nut 20 with respect to the structure. The fastening system 10, and particularly the breakaway nut 40 and/neck portion 30, may be modified as needed such that the breakaway nut 40 is designed to break away from structural nut 20 according to desired tensions of varying applications.

In preferred embodiments, the circumference of the structural nut 20 includes a shape (e.g., hexagonal) such that it is also configured to be rotated by a hand tool (e.g., socket wrench). Thus, the structural nut 20 can be re-tightened or removed if needed after the breakaway nut 40 has broken away from the structural nut 20.

In preferred embodiments, the breakaway nut 40 includes a larger circumference than the circumference of the structural nut 20 such that the hand tool spins freely around the structural nut 20 when being used to rotate the breakaway nut 40. The larger circumference of the breakaway nut 40 also helps prevent, or otherwise makes it difficult, for a user to apply torque to the structural nut 20 independently from the breakaway nut 40 prior to the shearing apart of the breakaway nut 40 from the fastening system 10.

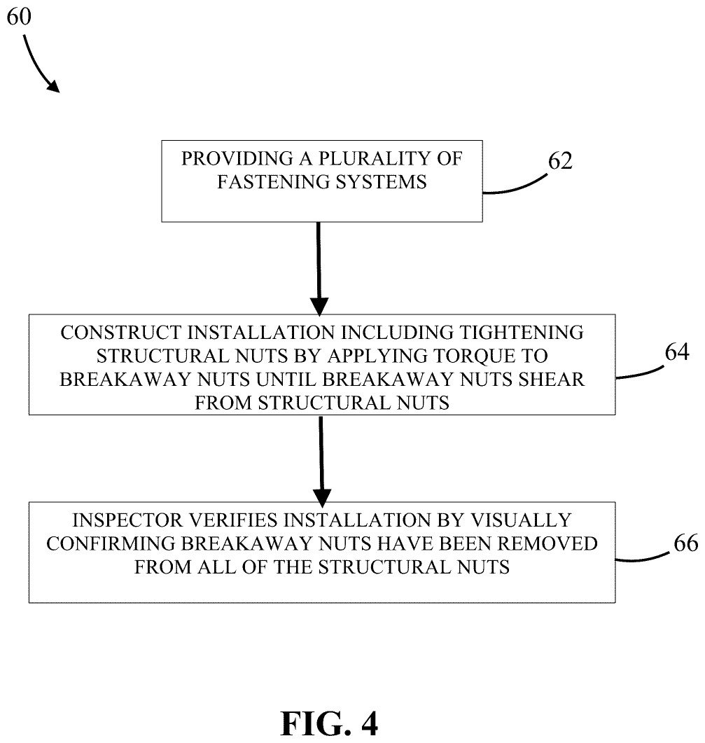

According to another aspect of the disclosure, and with reference to FIG. 4, a method 60 for verifying desired tension of a plurality of fastening systems 10 at an installation site is disclosed. According to method 60, a first step 62 includes providing a plurality of fastening systems 10 as described above each having a structural nut 20, a breakaway nut 40, and a neck portion 30 that connects the structural nut 20 to the breakaway nut 40. At step 64, an installer utilizes the plurality of fastening systems 10 to construct an installation at an installation site by (1) applying each of the fastening systems to one of a plurality of bolts inserted into a structure; and (2) tightening each of the structural nuts 20 to a desired tension with respect to the structure by applying torque to the breakaway nut 40 until the breakaway nut 40 shears from the structural nut 20. At step 66, an inspector (which could be the same person as the installer), verifies that each of the structural nuts 20 have been sufficiently tightened with respect to the structure at the installation site by visually confirming that each of the breakaway nuts 40 used in the installation have been removed from the structural nuts 20. According to certain embodiments, and particularly in situations in which the installation is in a dangerous or hard to access location (e.g., cell towers, bridges, etc.), the visual inspection may be easily and safely accomplished using a drone.

According to another aspect of the disclosure, different sets of fastening systems 10 as described herein are provided at step 62 with varying tensions needed to shear the breakaway nut 40 from the structural nut 20. As a result, the plurality of fastening systems 10 include different sets of fastening systems having varying tensions in which the structural nut 20 is intended to be tightened with respect to the structure upon installation. Thus, at step 64, the installer controls the desired tension for the structural nut 20 with respect to the structure for a particular installation by selecting fastening systems having an appropriate breakaway tension when torque is applied to the breakaway nut 40.

Relatedly, below are exemplary size ranges for the breakaway nut 40 (by bolt diameter in which the fastening system 10 is intended to be secured) with corresponding torque/tension values according to exemplary embodiments:

| Bolt Diameter | Required Tension Kips | Torque Average |
|---|---|---|
| ½″ | 12 | 100 |
| ⅝″ | 19 | 200 |
| ¾″ | 28 | 350 |

What is claimed is:

1. A fastening system for receiving an associated screw for joining parts together to form a structure, the fastening system comprising:
a structural nut;
a breakaway nut having a circumference that includes a shape that is configured to be engaged by a hand tool for rotating the breakaway nut;
wherein, upon rotation of the breakaway nut with respect to the associated screw, the structural nut is tightened against the structure to a desired tension whereupon the breakaway nut is dimensioned and configured to shear apart from the structural nut.

2. The fastening system of claim 1 further comprising a neck portion for joining the breakaway nut to the structural nut.

3. The fastening system of claim 2 wherein the circumference of the breakaway nut and neck portion are dimensioned and configured to prevent the hand tool from applying a rotational force directly to the structural nut prior to the breakaway nut being sheared apart from the structural nut.

4. The fastening system of claim 3 wherein the structural nut has a circumference that includes a shape that is configured to be engaged by a hand tool for rotating the structural nut after the breakaway nut is sheared apart from the structural nut.

5. A method for verifying proper installation of a structure at an installation site, the method comprising:
providing a plurality of fastening systems each for receiving an associated screw for joining parts together to form the structure at the installation site, each of the plurality of fastening systems including:
a structural nut, and
a breakaway nut having a circumference that includes a shape that is configured to be engaged by a hand tool for rotating the breakaway nut, the breakaway nut being operable to shear away from the structural nut upon the structural nut being tightened against the structure to a desired tension;
installing the plurality of fastening systems to construct the structure by applying each of the fastening systems to one of a plurality of bolts inserted into the structure and tightening each of the structural nuts to the desired tension with respect to the structure by applying torque to the breakaway nuts until the breakaway nuts shear away from each of their respective structural nuts; and
verifying that each of the structural nuts have been sufficiently tightened with respect to the structure by visually confirming that each of the breakaway nuts have been sheared away from each of their respective structural nuts.

6. The method of claim 5 wherein the providing step includes providing a first set of fastening systems and a second set of fastening systems, the first set of fastening systems having a first desired tension in which the breakaway nut is operable to shear away from the structural nut and the second set of fastening systems having a second desired tension in which the breakaway nut is operable to shear away from the structural nut, the second desired tension being different than the first desired tension.

7. The method of claim 6 wherein the installing step includes selecting one of the first set of fastening systems and the second set of fastening systems for installation based at least in part on the desired tension being one of the first desired tension and the second desired tension.

8. The method of claim 5 wherein each of the plurality of fastening systems further include a neck portion for joining the breakaway nut to the structural nut.

9. The method of claim 5 wherein the circumference of the breakaway nut for each of the plurality of fastening systems is dimensioned and configured to prevent the hand tool from applying a rotational force directly to the structural nut prior to the breakaway nut being sheared apart from the structural nut.

10. The method of claim 9 wherein the structural nut of each of the plurality of fastening systems has a circumference that includes a shape that is configured to be engaged by a hand tool for rotating the structural nut after the breakaway nut is sheared apart from the structural nut.
